(19) United States
(12) Patent Application Publication
(10) Pub. No.: US 2010/0100635 A1
(43) Pub. Date: Apr. 22, 2010

(54) Reception Apparatus, Content Reception Method, and Program

(76) Inventors: Tomoaki TAKEMURA, Tokyo (JP); Shinya Masunaga, Tokyo (JP); Yoshikatsu Niwa, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/579,048

(22) Filed: Oct. 14, 2009

(30) Foreign Application Priority Data
Oct. 16, 2008 (JP) P2008-267693

(51) Int. Cl. G06F 15/16

(52) U.S. Cl. 709/231

(57) ABSTRACT

A reception apparatus includes a download section, a storage section, a judgment section, and a presentation section. The download section downloads a content via a network. The storage section stores the content being downloaded. The judgment section judges, based on a transmission rate of the content being downloaded and a standard reproduction rate of the content, whether the content can be reproduced continuously. The presentation section presents a result of the judgment to a user.

### BACKGROUND OF THE INVENTION

1. Field of the Invention

The present invention relates to a reception apparatus for receiving a content via a network, a content reception method for receiving the content, and a program therefor.

2. Description of the Related Art

Along with prevalence of high-speed stream communication network, there are already provided content download services that deliver various contents such as music, moving images, and computer programs by a download method.

In general, a download is a method in which a content cannot be reproduced until an entire stream is downloaded. In contrast, there is a progressive download as a delivery method in which a content can be reproduced while being downloaded as in streaming. The progressive download is different from the streaming in that a stream remains in a reception apparatus after being downloaded and a content of the stream can be reproduced infinitely.

In the progressive download, when an actual transmission rate falls below a rate required for reproduction (standard reproduction rate of target content) due to a fluctuation of transmission characteristics of a network, an underflow of a buffer occurs, with the result that reproduction becomes fragmentary (repetition of reproduction and reproduction interrupt).

Japanese Patent Application Laid-open No. 2007-311902 (hereinafter, referred to as Patent Document 1) discloses a technique as follows for suppressing a frequency of occurrence of a buffer underflow. A device that receives and reproduces a stream monitors an accumulation amount of streams in a buffer and when the accumulation amount becomes a first threshold value or less, stops decoding the stream at a position at which a pause can be made. After that, the stream accumulation amount of the buffer increases with time. Then, when the stream accumulation amount of the buffer becomes a second threshold value or more (first threshold value <second threshold value), the device resumes the decode of the stream. Here, as a position at which the stream can be paused, a position between songs is exemplified in Patent Document 1.

### SUMMARY OF THE INVENTION

As described above, when the stream transmission rate decreases to fall below a rate necessary for reproduction due to a change in the transmission characteristics of the network, smooth continuous reproduction cannot be made because of the buffer underflow. Moreover, since the system disclosed in Patent Document 1 requires a stream to have many positions at which a pause can be made, the system is unfit for continuously reproducing a stream like moving images.

In view of the circumstances as described above, there is a need for a reception apparatus, a content reception method, and a computer program that are suitable for a progressive download of a content.

According to an embodiment of the present invention, there is provided a reception apparatus including a download means, a storage section, a judgment means, and a presentation means. The download means downloads a content via a network. The storage section stores the content being downloaded. The judgment means judges, based on a transmission rate of the content being downloaded and a standard reproduction rate of the content, whether the content can be reproduced continuously. The presentation means presents a result of the judgment to a user.

By judging whether the content being downloaded can be reproduced continuously based on the transmission rate of the content being downloaded and the standard transmission rate of the content and presenting the result to the user, the user can instruct reproduction of a content after contents are narrowed down to contents that can be reproduced continuously.

The reception apparatus according to the embodiment of the present invention further includes an input means for inputting a reproduction instruction of the content being downloaded as a response from the user with respect to the result of the judgment judged by the judgment means, and a control means for performing control so that the content being downloaded is reproduced when an instruction to reproduce the content is input. With this structure, the content being downloaded can be reproduced.

In the reception apparatus according to the embodiment of the present invention, the download means may measure the transmission rate of the content being downloaded, and the judgment means may judge, when an instruction to reproduce the content being downloaded is input, whether the content can be reproduced continuously based on the transmission rate measured by the download means and the standard reproduction rate of the content. With this structure, the transmission rate of each content being downloaded that is used for the judgment by the judgment means can be obtained.

In the reception apparatus according to the embodiment of the present invention, the judgment means may calculate, when it is judged that the content cannot be reproduced continuously, a wait time required until the download of the content ends, and the presentation means may present to the user the wait time together with the result of the judgment. With this structure, the user is capable of grasping a wait time required until the download of the content ends.

In the reception apparatus according to the embodiment of the present invention, the download means may preferentially download, in a state where a plurality of contents can be downloaded at the same time, the content when it is judged by the judgment means that the content cannot be reproduced continuously. By preferentially downloading the content to be reproduced, a download that enables continuous reproduction to be carried out as much as possible becomes possible.

The download means may stop, for preferentially downloading the content to be reproduced, downloads of contents other than the content to be reproduced. With this structure, it is possible to at least prevent continuous reproduction from being disabled due to a low download priority and a small resource (e.g., network band) allocation.

The download means may be structured to be capable of downloading a plurality of contents at the same time, and the judgment means may judge a content that is capable of being reproduced continuously based on the transmission rate of each content being downloaded and the standard reproduction rate of the content.

Furthermore, the download means may measure the transmission rate of each content being downloaded in a state where downloads of contents other than the content as a target of the measurement are stopped, and the judgment means may judge, based on the transmission rate of each content being downloaded and the standard reproduction rate of the content, a content that is capable of being reproduced continuously while the downloads of contents other than the content as the target of the measurement are stopped.

According to another embodiment of the present invention, there is provided a content reception method including: downloading a content via a network; storing the content being downloaded in a storage section; judging, based on a transmission rate of the content being downloaded and a standard reproduction rate of the content, whether the content can be reproduced continuously; and presenting a result of the judgment to a user.

According to another embodiment of the present invention, there is provided a program causing a computer to operate as a reception apparatus, the program causing the computer to function as a download means, a storage section, a judgment means, and a presentation means. The download means downloads a content via a network. The storage section stores the content being downloaded. The judgment means judges, based on a transmission rate of the content being downloaded and a standard reproduction rate of the content, whether the content can be reproduced continuously. The presentation means presents a result of the judgment to a user.

According to the embodiments of the present invention, a reception apparatus, a content reception method, and a computer program that are suitable for a progressive download of a content can be provided.

These and other objects, features and advantages of the present invention will become more apparent in light of the following detailed description of best mode embodiments thereof, as illustrated in the accompanying drawings.

### BRIEF DESCRIPTION OF DRAWINGS

FIG. 1 is a schematic diagram of a content download system to which an embodiment of the present invention is applied;

FIG. 2 is a diagram showing structures of a reception apparatus and a delivery apparatus in the content download system shown in FIG. 1;

FIG. 3 is a diagram specifically showing the structure of the reception apparatus shown in FIG. 2;

FIG. 4 is a flowchart of processing for obtaining a download priority of a content;

FIG. 5 is a flowchart showing control for starting a download based on the priority;

FIG. 6 is a diagram showing a display example of a content list;

FIG. 7 is a flowchart of processing carried out in a case where a user has selected a content to reproduce in the content list shown in FIG. 6 and has input a reproduction request;

FIG. 8 is a diagram showing a display example of a warning message;

FIG. 9 is a flowchart showing an operation of a second modified example of the first embodiment;

FIG. 10 is a diagram showing another display example of the content list;

FIG. 11 is a diagram showing a first display example of a dialog presented to the user to notify that a progressive download of a content can favorably be carried out;

FIG. 12 is a flowchart showing an operation of a third modified example of the first embodiment;

FIG. 13 is a diagram showing another display example of the content list; and

FIG. 14 is a diagram showing a second display example of the dialog presented to the user to notify that a progressive download of a content can favorably be carried out.

### DESCRIPTION OF PREFERRED EMBODIMENTS

Hereinafter, an embodiment of the present invention will be described with reference to the drawings.

### First Embodiment

### Structure of Content Download System

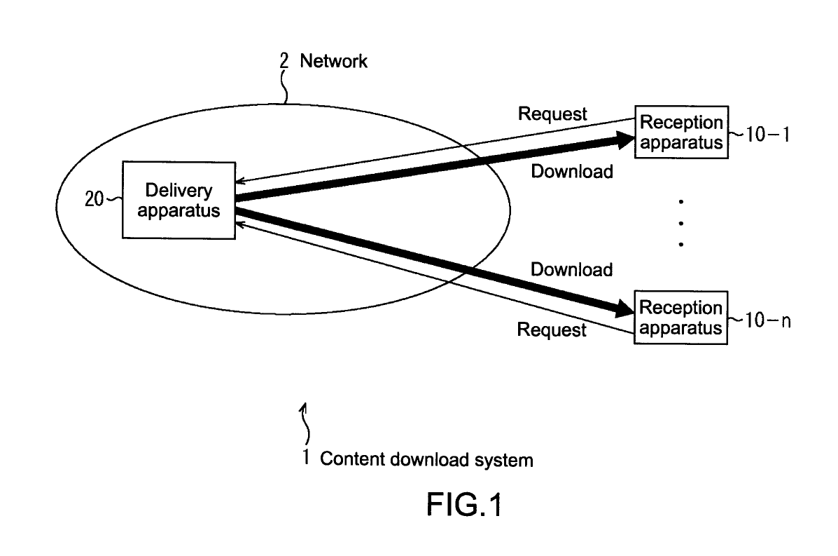

FIG. 1 shows a basic picture of a content download system according to a first embodiment of the present invention.

A content download system 1 is constituted of a reception apparatus 10 installed in a residence of a user who views a content and a delivery apparatus 20 that delivers a content to the reception apparatus 10 by a download method in response to a request from the reception apparatus 10 connected thereto via a network 2.

It should be noted that a download refers to processing in which the reception apparatus 10 causes the delivery apparatus 20 to transfer a stream such as a content via the network 2 and accumulates the stream therein. However, while a stream cannot be reproduced until the reception apparatus 10 has downloaded the entire stream in the download, in the progressive download (hereinafter, abbreviated to “PDL”), a stream of a content is delivered from the top in terms of a time to be reproduced and the stream of the content can be reproduced while being downloaded by the reception apparatus 10. The content used herein refers to an encrypted stream including a moving image stream and an audio stream and subtitle stream corresponding to the moving image stream.

The network 2 is a communication network typified by the Internet.

The reception apparatus 10 only needs to be an apparatus that is capable of acquiring a stream of a content by a download and reproducing it, for example. Specific examples of the reception apparatus 10 include computer equipment such as a PC (Personal Computer), a television receiver, a cellular phone, a PDA (Personal Digital Assistant), and recording equipment.

The delivery apparatus 20 is constituted of a plurality of servers provided on the network 2. The delivery apparatus 20 receives a request to download a content stream from the reception apparatus 10 connected thereto via the network 2 and delivers the content stream to the reception apparatus 10.

(Structures of Reception Apparatus 10 and Delivery Apparatus 20)

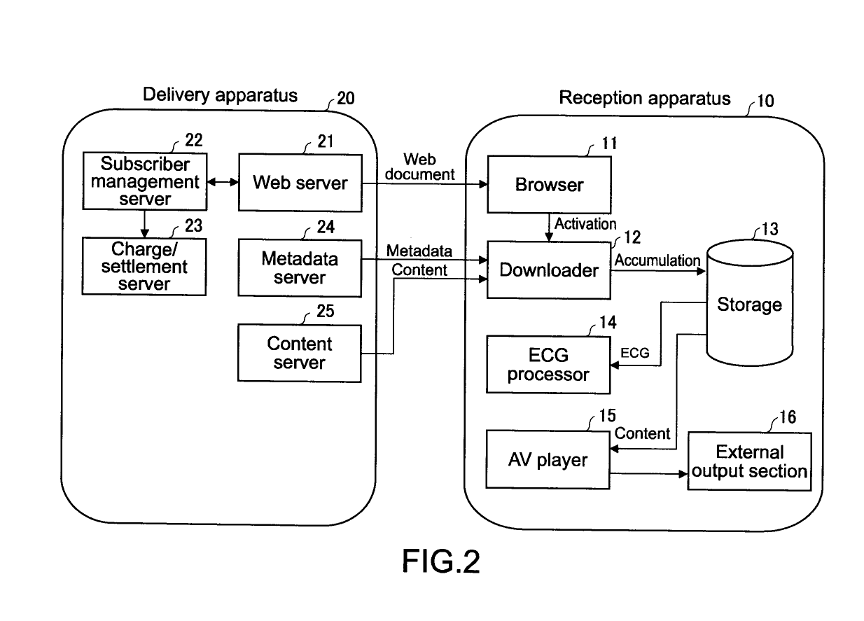

Next, referring to FIG. 2, structures of the reception apparatus 10 and the delivery apparatus 20 of the content download system 1 will be described.

The reception apparatus 10 includes a browser 11, a downloader 12, a storage 13, an ECG (Electronic Contents Guide) processor 14, an AV player 15, and an external output section 16.

Based on an HTML (Hypertext Markup Language) document, a BML (Broadcast Markup Language) document, or the like acquired from the delivery apparatus 20, the browser 11 causes a webpage, on which a user can interactively make an operation such as selecting a content to download, to be displayed. The BML is a page description language for XML (Extensible Markup Language)-based data broadcasts.

The downloader 12 is activated under control of the browser 11 and causes contents or metadata of the contents to be downloaded from the delivery apparatus 20, and accumulates them in the storage 13. Moreover, the downloader 12 determines a priority of each download among a plurality of downloads based on a predetermined judgment condition and schedules to start a download from that having a higher priority. Further, the downloader 12 measures transmission rates of each content being downloaded and records in the storage 13 a mean value of the transmission rates and information on a download condition such as a remaining content size. Furthermore, the downloader 12 carries out processing of comparing, for each download, the mean value of the transmission rates and a standard reproduction rate of a content, judging whether a PDL can be carried out favorably (without being interrupted), and notifying the ECG processor 14 to present a result of the judgment to the user, for example.

The storage 13 is, for example, a hard disk drive, and stores a mean value of transmission rates of a content being downloaded and information on a download condition such as a remaining content size to be downloaded as well as metadata and a stream of a content.

Based on the metadata of a content, the ECG processor 14 generates a list of contents accumulated in the storage 13 by the download and presents the list to the user to thus prompt the user to select a content to view from the list. Upon being notified of the result of the judgment on whether the PDL can be favorably carried out (without interruption) by the downloader 12, the ECG processor 14 carries out processing of presenting a content of the notification to the user. The ECG processor 14 also transfers a response of the user with respect to the content presented to the user to the downloader 12.

The AV player 15 decodes the content read out from the storage 13, causes a display (not shown) to display a video corresponding to AV data obtained as a result of the decode, and also causes a speaker (not shown) to output audio.

The external output section 16 converts a format of the AV data supplied from the AV player 15 into a designated format of an output destination (e.g., removable medium, reproducing apparatus, and recording apparatus) and outputs the converted data.

Next, referring to FIG. 2, the structure of the delivery apparatus 20 of the content download system 1 will be described.

The delivery apparatus 20 is constituted of a web server 21, a subscriber management server 22, a charge/settlement server 23, a metadata server 24, a content server 25, and the like.

The web server 21 supplies an HTML document, a BML document, and the like used for the reception apparatus 10 to display an interactive webpage.

The subscriber management server 22 manages a subscriber (user of reception apparatus 10) ID, a password, and settlement information (e.g., credit card number) of a subscriber in association with a content downloaded by that subscriber.

The charge/settlement server 23 carries out charge/settlement processing with respect to the subscriber in response to a request from the subscriber management server 22.

The metadata server 24 transfers metadata on a content to the reception apparatus 10. The metadata used herein refers to data including a content ID, a URL (Uniform Resource Locator) that indicates a location of a content, a brief overview of a content, a size-reduced image if a content is a moving image, and the like.

(Specific Structure of Reception Apparatus 10)

Next, the structure of the reception apparatus 10 will be described in more detail.

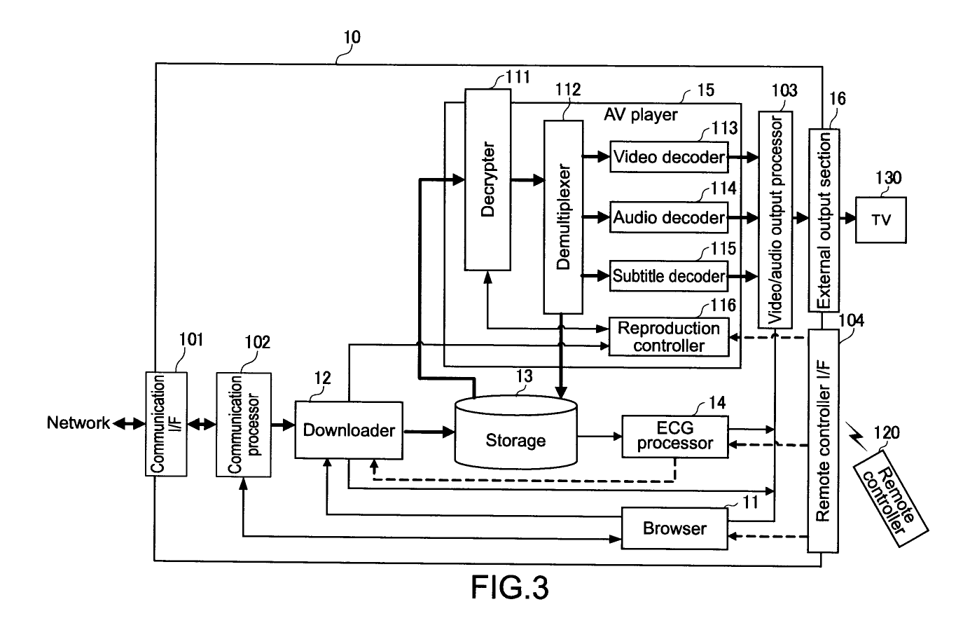

FIG. 3 is a block diagram showing the structure of the reception apparatus 10.

As shown in the figure, the reception apparatus 10 includes, in addition to the browser 11, the downloader 12, the storage 13, the ECG processor 14, the AV player 15, and the external output section 16, a communication interface section 101, a communication processor 102, a video/audio output processor 103, and a remote controller interface 104.

The communication interface section 101 is a physical interface that connects the reception apparatus 10 to the network 2.

The communication processor 102 is, for example, a module that processes an HTTP network protocol. The browser 11 and the downloader 12 exchange various streams according to HTTP with the servers of the delivery apparatus 20 via the communication processor 102. For example, the communication processor 102 transmits HTTP requests from the browser 11 and the downloader 12 to the servers in the delivery apparatus 20, receives HTTP responses from the servers in the delivery apparatus 20, and supplies them to the browser 11 and the downloader 12.

The AV player 15 includes a decrypter 111, a demultiplexer 112, a video decoder 113, an audio decoder 114, a subtitle decoder 115, and a reproduction controller 116.

The decrypter 111 decodes a stream of a content stored in the storage 13. The demultiplexer 112 separates the content stream decoded by the decrypter 111 into a video stream, an audio stream, a subtitle stream, and the like. The video decoder 113 decodes the video stream separated by the demultiplexer 112. The audio decoder 114 decodes the audio stream separated by the demultiplexer 112. The subtitle decoder 115 decodes the subtitle stream separated by the demultiplexer 112. The reproduction controller 116 executes processing for various operations such as reproduction/stop/pause that are input by the user using a remote controller 120 or the like.

The video/audio output processor 103 generates display data by integrating an output of the video decoder 113, an output of the subtitle decoder 115, and an image generated by the browser 11 and outputs the generated data to a video/audio output apparatus 130 such as an external television via the external output section 16. The video/audio output processor 103 also outputs an output of the audio decoder 114 to the video/audio output apparatus 130 such as an external television via the external output section 16.

It should be noted that it is also possible to provide a video display section and an audio output section in the reception apparatus 10 so that data obtained by decoding a video stream and audio stream is output thereto.

The remote controller interface 104 is an interface for transmitting and receiving radio signals such as infrared ray signals to/from the remote controller 120. The remote controller interface 104 notifies the reproduction controller 116 in the AV player 15, the browser 11, and other blocks of various instructions input by the user via the remote controller 120.

The structure of the reception apparatus 10 according to the first embodiment of the present invention is as described above.

(Operation of Reception Apparatus 10)

Next, an operation of the reception apparatus 10 will be described.

As preprocessing for downloading a content, the browser 11 of the reception apparatus 10 accesses the web server 21 of the delivery apparatus 20 to acquire a webpage on which a list of downloadable contents is described, and displays it. A user of the reception apparatus 10 selects a content to download from the displayed list of downloadable contents and inputs a download request to the browser 11. The browser 11 activates the downloader 12 according to the download request and requests the downloader 12 to download metadata of that content. It should be noted that when downloading a paid content, a procedural exchange for purchasing the content is carried out prior to the download.

Upon receiving the download request of the content, the downloader 12 queues the download request. After that, the downloader 12 determines a priority for all the queued download requests. All the queued download requests include a download request for which a download is being executed and a download request for which a download is not yet started.

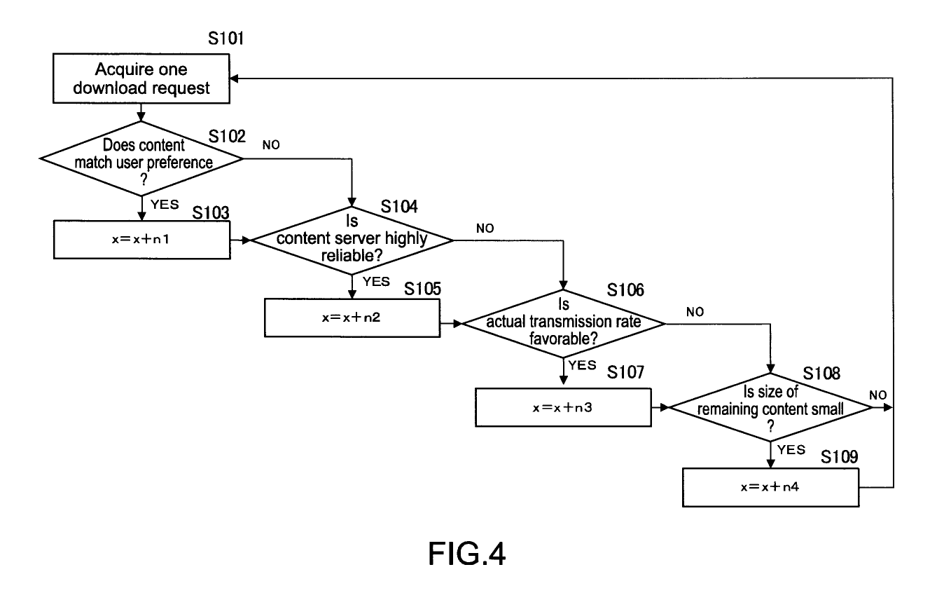

FIG. 4 is a flowchart of processing for determining a priority of a download of a content.

With respect to all the download requests, the downloader 12 determines a priority one by one (Step S101) based on the following criteria.

### 1. User Preference

If a content matches a preference of a user, a priority x is incremented only by n1. Here, an initial value of the priority x is 0. n1 is an integer of 1 or more. A judgment on whether a content matches a preference of a user is carried out as follows, for example. Every time a content is viewed, the reception apparatus 10 extracts information on the content, for example, information including a title, a genre, casts, and the like from metadata of the content and accumulates the extracted information. Based on the accumulated user viewing history, the reception apparatus 10 judges the information including a title, a genre, casts, and the like that matches the user preference by a statistical method and generates user preference information based on a result of the judgment. Then, by comparing the information including a title, a genre, casts, and the like of the content to be downloaded with the user preference information, the downloader 12 judges whether the content matches the user preference. n1 may be variable according to a matching degree (Steps S102 and S103).

### 2. Credibility of Content Server

If credibility of a content server as a download request destination is high, the priority x is additionally incremented only by n2. n2 is an integer of 1 or more. Here, the credibility of a content server is evaluated based on a mean value of past download transmission rates, fluctuation characteristics, and the like. n2 may be variable according to a result of evaluating the credibility of a content server. Even if a mean value of transmission rates is high, unless a fluctuation is small, it is difficult to perform reproduction without interruption. Also, even if a fluctuation of the transmission rates is small, unless the mean value of transmission rates is higher than a standard reproduction rate of a content, it is difficult to perform favorable reproduction. Therefore, for ensuring favorable reproduction, it is necessary for the mean value of past transmission rates to be higher than the standard reproduction rate and also a fluctuation of the past transmission rates to be small. For performing such an evaluation, the downloader 12 measures transmission rates in downloading a content for each content server, obtains a mean value and fluctuation characteristics of the transmission rates, and records them. It should be noted that information on the standard reproduction rate of a content can be acquired from metadata of the content or by inquiring the content server, for example (Steps S104 and S105).

### 3. Actual Transmission Rate

For a download request for which a download has already been started, it is possible to predict whether a content to be downloaded can be favorably reproduced by comparing the mean value of transmission rates measured during the download with the standard reproduction rate. In this regard, if the mean value of the actually-measured transmission rates is higher than the standard reproduction rate, the priority x is incremented only by n3. n3 is an integer of 1 or more (Steps S106 and S107).

### 4. Remaining Download Size

When a remaining content size to be downloaded is small, the priority x is additionally incremented only by n4. n4 is an integer of 1 or more. When a download of one content is completed, a network band is freed that much, and the freed network band is allocated to a download of a content. Therefore, n4 may be increased as a remaining content size decreases (Steps S108 and S109).

The downloader 12 determines a priority of each download request based on the evaluation criteria described above. The calculation of a priority is carried out in a certain time cycle, and a priority determined in a previous cycle is overwritten (updated) by a priority determined in the next cycle. It should be noted that the order of the evaluation is not limited.

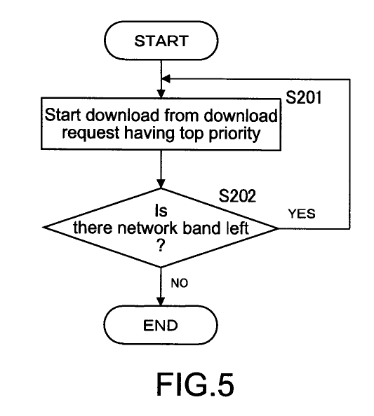

FIG. 5 is a flowchart showing control for starting a download based on a priority.

Upon completing the calculation of priorities of all download requests, the downloader 12 sequentially starts the download from a download request with a highest priority (Step S201). At this time, the download request having a higher priority is preferentially allocated with a resource necessary for a download, such as a network band that the reception apparatus 10 can use. Then, when there is no resource such as a network band left (NO in Step S202), the downloader 12 sets a start of downloads of download requests having lower priorities to standby.

A content being downloaded or already downloaded is accumulated in the storage 13 in association with a content ID for identifying that content.

Next, a description will be given on a case where a user has input a display request for displaying a content list for selecting a content to reproduce using the remote controller 120.

The display request is input to the ECG processor 14 via the remote controller interface 104. While referencing metadata or the like accumulated in the storage 13, the ECG processor 14 generates list data of contents being downloaded and contents already downloaded by the download and outputs the content list data to the video/audio output processor 103. The video/audio output processor 103 converts the content list data into a video signal displayable on the video/audio output apparatus 130 such as an external television and outputs the signal to the video/audio output apparatus 130 via the external output section 16. As a result, a content list for prompting the user to select a content to view is displayed on the video/audio output apparatus 130.

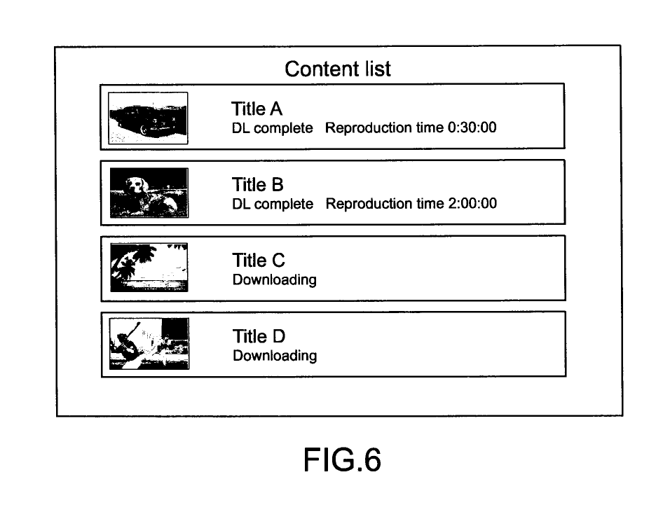

FIG. 6 is a diagram showing a display example of the content list. As shown in the figure, displayed for each content in the content list are a title name, information indicating which of “downloading” or “downloaded” a status of the content is, a content length (reproduction time), a size-reduced still image of the content, and the like.

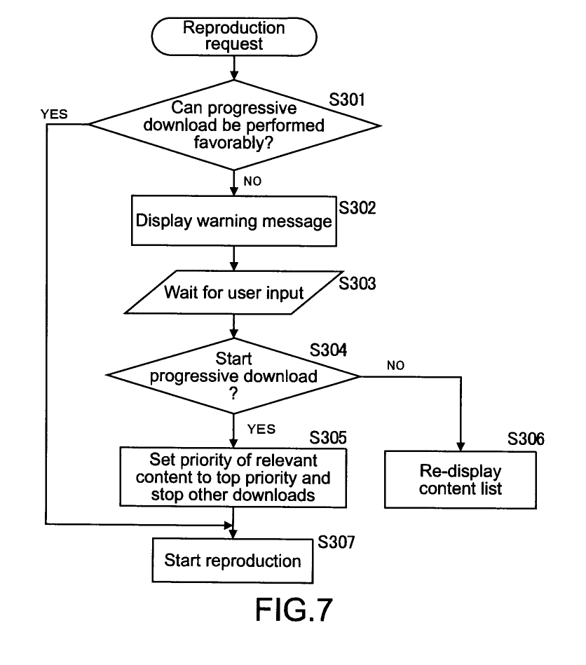

FIG. 7 is a flowchart of processing carried out in a case where the user has selected a content to reproduce in the content list shown in FIG. 6 and has input a reproduction request.

Assuming that the user has input a reproduction request of one content being downloaded in the content list shown in FIG. 6 using the remote controller 120, the reproduction request from the user is input to the ECG processor 14 via the remote controller interface 104. Upon receiving the reproduction request, the ECG processor 14 instructs the downloader 12 to execute the following judgment processing.

By reading out information on the mean value of content transmission rates and information on the standard reproduction rate of the content and comparing those two, the downloader 12 judges whether a PDL can be carried out favorably. In other words, the downloader 12 judges that the PDL can be favorably carried out when judging that the mean value of content transmission rates is higher than the standard reproduction rate of the content, for example, and thus instructs the reproduction controller 116 in the AV player 15 to reproduce the content. Accordingly, the reproduction (PDL) of the content is started (Step S307).

Further, when judging that the mean value of the content transmission rates is equal to or smaller than the standard reproduction rate of the content, for example, the downloader 12 judges that the PDL cannot be carried out favorably. Then, the downloader 12 instructs the ECG processor 14 to display a warning message to that effect. Upon receiving the instruction, the ECG processor 14 outputs warning message data to the video/audio output processor 103. The video/audio output processor 103 generates display data based on the warning message data acquired from the ECG processor 14 and outputs the display data to the video/audio output apparatus 130 such as an external television via the external output section 16 (Step S302).

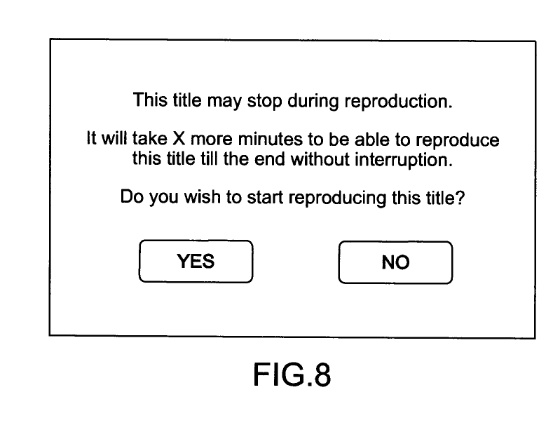

FIG. 8 is a diagram showing a display example of the warning message. To the warning message, a wait time X required until reproduction can be performed without being interrupted till the end is added. The wait time X is obtained as follows, for example. The downloader 12 reads a remaining content size to be downloaded and a mean value of transmission rates and divides the remaining size by the mean value of transmission rates. Thus, the wait time X is obtained. In other words, the wait time X is a wait time required until a download of the content ends.

After that, the downloader 12 waits for a response from the user (Step S303). Specifically, in this case, the user determines whether to instruct a start of the reproduction in consideration of the warning message (Step S304) and transmits the result as a response using the remote controller 120. When instructed by the user not to start the reproduction, the ECG processor 14 generates the content list data again and outputs it to the video/audio output processor 103 (Step S306). Moreover, when instructed by the user to start the reproduction, the ECG processor 14 instructs the downloader 12 to execute the following processing.

Specifically, the downloader 12 stops downloads of all other contents as well as sets a download priority of a content for which the instruction to start the reproduction has been made, to a top priority (Step S305). Then, the downloader 12 starts the download of the content and simultaneously instructs the reproduction controller 116 in the AV player 15 to reproduce the content (Step S307). Accordingly, the reproduction (PDL) of that content is started. It should be noted that, a favorable PDL is not necessarily ensured in this case.

As described above, according to this embodiment, by judging whether a PDL of a content being downloaded can be carried out favorably and presenting a result of the judgment to the user, it is possible for the user to narrow down the contents to contents with which a favorable PDL can be performed and instruct a start of the reproduction. Moreover, by displaying, when a favorable PDL cannot be performed on a content being downloaded, a time required until the download of that content ends as the wait time X that indicates a time required until a PDL of that content can favorably be carried out, user operability is improved.

Furthermore, in this embodiment, when an instruction is made by the user to start reproduction of a content with which a PDL cannot be carried out favorably, the download priority of the content is set to a top priority and downloads of all other contents are stopped. As a result, the PDL of that content can be carried out in as favorable a manner as possible. For example, a PDL failure that is due to a low download priority and a small resource (e.g., network band) allocation can be prevented.

### First Modified Example

Next, a first modified example of the first embodiment will be described.

For judging whether a PDL can be carried out favorably, in the first embodiment, a mean value of download velocities measured while a content is received has been used. By this method, however, highly-credible information cannot be obtained as the mean value of transmission rates when a download is not yet started or the download is barely started, with the result that it is difficult to conduct the judgment above with accuracy.

In this regard, in the first modified example, when an instruction is given by the user to start reproducing a content, the downloader 12 executes a download of only the content for which the instruction has been given to start the reproduction, for only a certain time period since that time point. In other words, other downloads that are being executed are stopped during that time period. The certain time period used herein refers to a time period preset so that a credible value can be obtained as the mean value of content transmission rates (e.g., several to several-ten seconds). During this time period, a fact that the transmission rates of the content are being measured is presented to the user.

Consequently, a highly-credible value can be obtained as the mean value of transmission rates of a content for which an instruction has been made to start reproduction, and a judgment on whether a PDL can be carried out favorably can be performed with high accuracy.

### Second Modified Example

Next, a second modified example of the first embodiment will be described.

In the second modified example, without depending on the instruction by the user to start reproducing a content, the downloader 12 measures transmission rates of each download, judges a download with which a PDL can be carried out favorably, and presents a result of the judgment to the user.

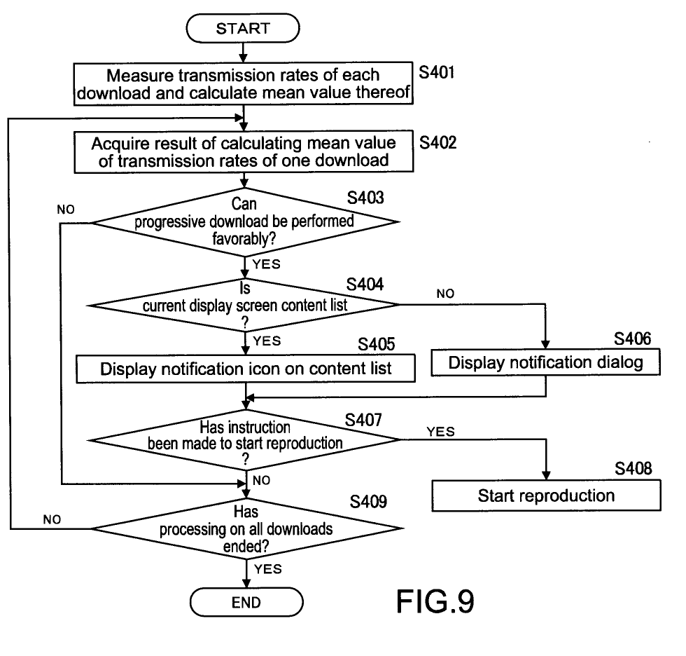

FIG. 9 is a flowchart showing an operation of the second modified example. The downloader 12 measures transmission rates in downloading each content and calculates a mean value of the transmission rates for each download (Step S401).

Next, the downloader 12 first focuses on the mean value of the transmission rates of one download out of the calculated results (Step S402). The downloader 12 compares the mean value of the transmission rates of this download with a standard reproduction rate of the content to be downloaded and judges whether a PDL of that content can be carried out favorably (Step S403). In other words, the downloader 12 judges that a PDL of the content can be carried out favorably when the mean value of the transmission rates of the download is higher than the standard reproduction rate of the content to be downloaded. Otherwise, the downloader 12 judges that a PDL cannot be carried out favorably.

When judging that a PDL cannot be carried out favorably, the downloader 12 judges whether the judgment processing described above on all the downloads has ended (Step S409). When the judgment processing on all the downloads is not yet ended, the downloader 12 returns to Step S402 and repeats the same judgment processing as described above on a mean value of transmission rates of the next download. It should be noted that when the judgment processing on all the downloads is ended, this flow is ended.

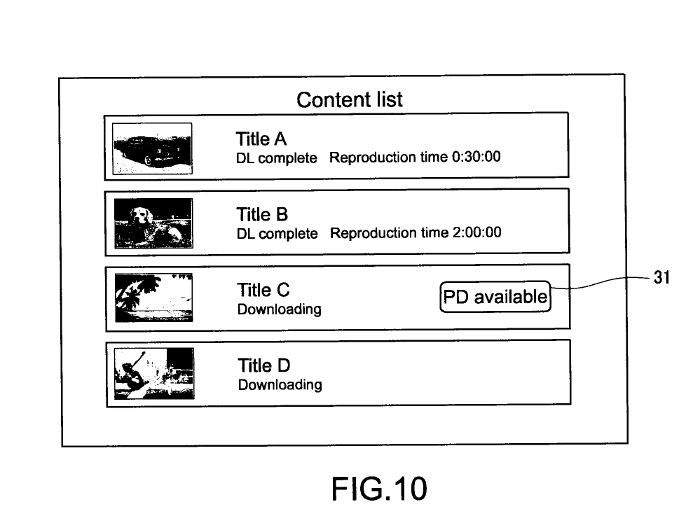

When judging that a PDL can be carried out favorably, the downloader 12 judges whether a current display screen is a content list (Step S404). When the current display screen is a content list, the downloader 12 instructs the ECG processor 14 to add information 31 such as an icon that indicates that a PDL of the content can be carried out favorably to the content list and display the list, as shown in FIG. 10, for example. In response to the instruction, the ECG processor 14 outputs data of a content list to which the information 31 such as an icon has been added, to the video/audio output processor 103. The video/audio output processor 103 generates display data based on the data of the content list to which the information 31 such as an icon has been added, and outputs the data to the video/audio output apparatus 130 such as an external television via the external output section 16 (Step S405). Using the remote controller 120, the user can identify a content for which a PDL can be performed and instruct to start reproducing the content in the content list.

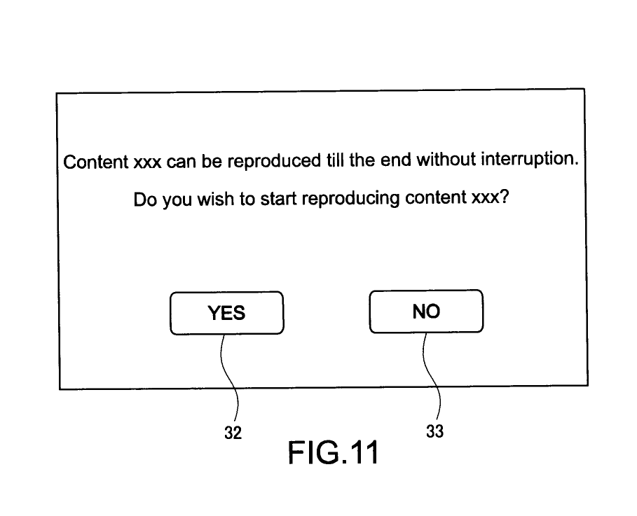

When the current display screen is a screen other than the content list (e.g., content reproduction screen), the downloader 12 instructs the ECG processor 14 to display a dialog that notifies the user that the PDL of the content can be favorably carried out as shown in FIG. 11, for example. In response to the instruction, the ECG processor 14 outputs data of the dialog to the video/audio output processor 103. The video/audio output processor 103 generates display data based on the data of the dialog and outputs the data to the video/audio output apparatus 130 such as an external television via the external output section 16 (Step S406). As shown in FIG. 11, in the dialog, a button 32 used for instructing a start of reproduction of the content and a button 33 used for canceling the start of the reproduction are displayed.

Upon receiving the instruction by the user to start the reproduction through the content list shown in FIG. 10 or the dialog shown in FIG. 11 (Step S407), the downloader 12 instructs the reproduction controller 116 in the AV player 15 to reproduce the content. As a result, the reproduction (PDL) of the content is started (Step S408).

Furthermore, the downloader 12 forwards the following operation unless instructed to start the reproduction by the content list shown in FIG. 10 or the dialog shown in FIG. 11. In other words, after displaying the content list shown in FIG. 10 or the dialog shown in FIG. 11, the downloader 12 judges whether the judgment processing has ended on all the downloads (Step S409). When the judgment processing on all the downloads is not yet ended, the downloader 12 returns to Step S402 and acquires a mean value of transmission rates of the next download, and repeats the same judgment processing as described above.

When the judgment processing on all the downloads is ended, the downloader 12 ends the processing of this flow.

It should be noted that the flow described above may be repeated automatically in certain time cycles in which a fluctuation may occur in transmission rates of each download.

According to the second modified example, it is possible to measure transmission rates of each download, judge a download for which a PDL can be carried out favorably, and present a result of the judgment to a user, without depending on an instruction from the user to start reproducing the content.

### Third Modified Example

In a third modified example, without depending on an instruction from the user to start reproducing a content, the downloader 12 measures transmission rates of each download in a state where other downloads are stopped, judges a download for which a PDL can be carried out favorably, and presents a result of the judgment to the user.

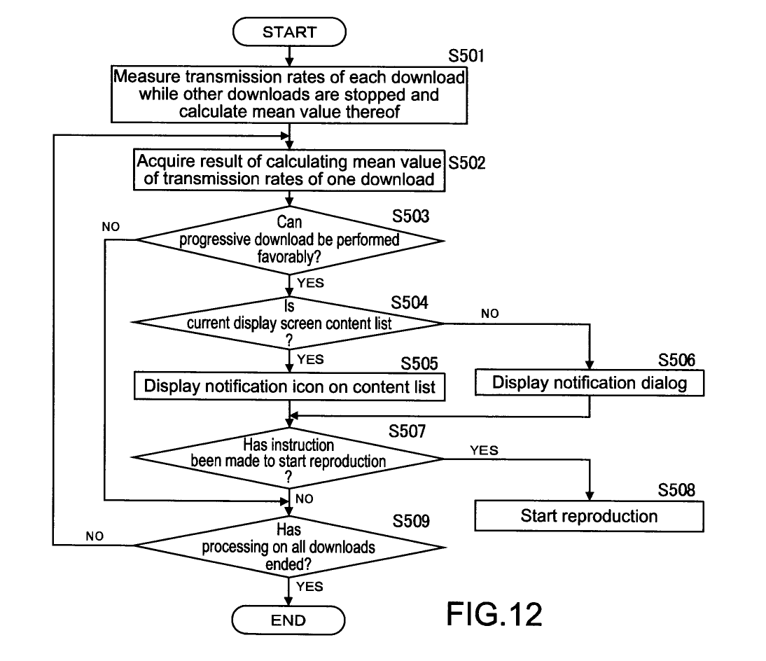

FIG. 12 is a flowchart showing an operation of the third modified example. The downloader 12 measures transmission rates of each download in a state where other downloads are stopped and calculates a mean value of the transmission rates for each download (Step S501).

Out of the calculated results, the downloader 12 first focuses on a mean value of transmission rates of one download (Step S502). The downloader 12 compares the mean value of the transmission rates of this download with a standard reproduction rate of a content to be downloaded and judges whether a PDL of the content can favorably be carried out while other downloads are stopped (Step S503). In other words, the downloader 12 judges that a PDL of the content can be carried out favorably when the mean value of the transmission rates of the download is higher than the standard reproduction rate of the content to be downloaded. Otherwise, the downloader 12 judges that a PDL cannot be carried out favorably.

When judging that a PDL cannot be carried out favorably, the downloader 12 judges whether the judgment processing described above on all the downloads has ended (Step S509). When the judgment processing on all the downloads is not yet ended, the downloader 12 returns to Step S502 and repeats the same judgment processing as described above on a mean value of transmission rates of the next download. It should be noted that when the judgment processing on all the downloads is ended, this flow is ended.

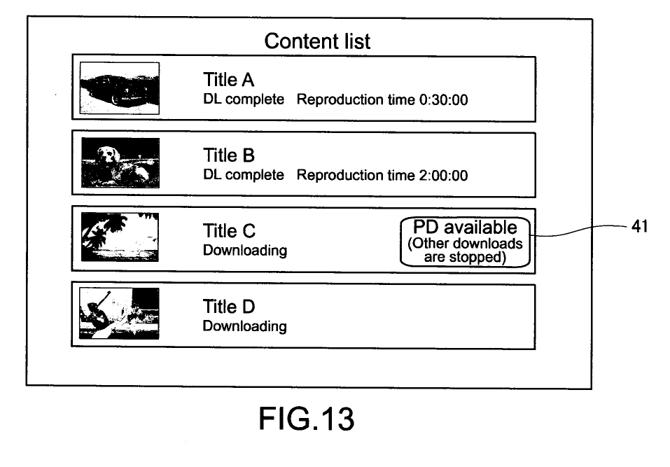

When judging that a PDL can be carried out favorably in a state where other downloads are stopped, the downloader 12 judges whether a current display screen is a content list (Step S504). When the current display screen is a content list, the downloader 12 instructs the ECG processor 14 to add information 41 such as an icon that indicates that a PDL of the content can be carried out favorably in the state where other downloads are stopped to the content list and display the list, as shown in FIG. 13, for example. In response to the instruction, the ECG processor 14 outputs data of a content list to which the information 41 such as an icon has been added, to the video/audio output processor 103. The video/audio output processor 103 generates display data based on the data of the content list to which the information 41 such as an icon has been added, and outputs the data to the video/audio output apparatus 130 such as an external television via the external output section 16 (Step S505). Using the remote controller 120, the user can identify a content for which a PDL can be performed favorably in the state where other downloads are stopped and instruct to start reproducing the content in the content list.

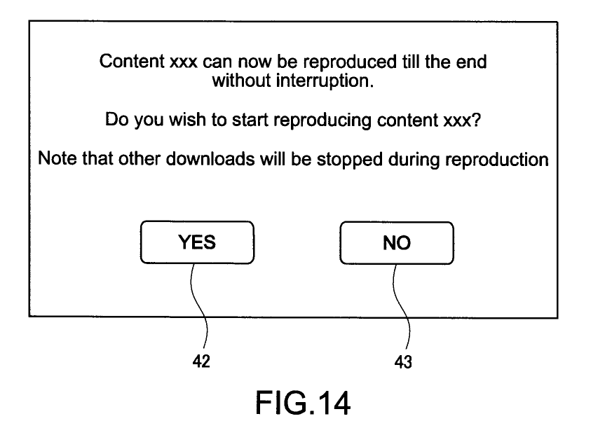

When the current display screen is a screen other than the content list (e.g., content reproduction screen), the downloader 12 instructs the ECG processor 14 to display a dialog that notifies the user that the PDL of the content can be favorably carried out in the state where other downloads are stopped as shown in FIG. 14, for example. In response to the instruction, the ECG processor 14 outputs data of the dialog to the video/audio output processor 103. The video/audio output processor 103 generates display data based on the data of the dialog and outputs the data to the video/audio output apparatus 130 such as an external television via the external output section 16 (Step S506). As shown in FIG. 14, in the dialog, a button 42 used for instructing a start of reproduction of the content and a button 43 used for canceling the start of the reproduction are displayed.

Upon receiving the instruction by the user to start the reproduction through the content list shown in FIG. 13 or the dialog shown in FIG. 14 (Step S507), the downloader 12 instructs the reproduction controller 116 in the AV player 15 to reproduce the content, and stops the downloads of contents other than the content for which the instruction has been made to start the reproduction. As a result, the reproduction (PDL) of the content is started (Step S508).

Furthermore, the downloader 12 forwards the following operation unless instructed to start the reproduction by the content list shown in FIG. 13 or the dialog shown in FIG. 14. In other words, after displaying the content list shown in FIG. 13 or the dialog shown in FIG. 14, the downloader 12 judges whether the judgment processing has ended on all the downloads (Step S509). When the judgment processing on all the downloads is not yet ended, the downloader 12 returns to Step S502 and acquires a mean value of transmission rates of the next download, and repeats the same judgment processing as described above.

When the judgment processing on all the downloads is ended, the downloader 12 ends the processing of this flow.

It should be noted that the flow described above may be repeated automatically in certain time cycles in which a fluctuation may occur in transmission rates of each download.

According to the third modified example, it is possible to measure transmission rates of each download in a state where downloads of other contents are stopped, judge a download for which a PDL can be carried out favorably, and present a result of the judgment to a user.

The present application contains subject matter related to that disclosed in Japanese Priority Patent Application JP 2008-267693 filed in the Japan Patent Office on Oct. 16, 2008, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A reception apparatus, comprising:
a download means for downloading a content via a network;
a storage section to store the content being downloaded;
a judgment means for judging, based on a transmission rate of the content being downloaded and a standard reproduction rate of the content, whether the content can be reproduced continuously; and
a presentation means for presenting a result of the judgment to a user.

2. The reception apparatus according to claim 1,
wherein the download means measures the transmission rate of the content being downloaded, and
wherein the judgment means judges, when an instruction to reproduce the content being downloaded is input, whether the content can be reproduced continuously based on the transmission rate measured by the download means and the standard reproduction rate of the content.

3. The reception apparatus according to claim 2,
wherein the judgment means calculates, when it is judged that the content cannot be reproduced continuously, a wait time required until the download of the content ends, and
wherein the presentation means presents to the user the wait time together with the result of the judgment.

4. The reception apparatus according to claim 3,
wherein the download means preferentially downloads, in a state where a plurality of contents can be downloaded at the same time, the content when it is judged by the judgment means that the content cannot be reproduced continuously.

5. The reception apparatus according to claim 4,
wherein the download means stops, for preferentially downloading the content to be reproduced, downloads of contents other than the content to be reproduced.

6. The reception apparatus according to claim 1,
wherein the download means is capable of downloading a plurality of contents at the same time, and
wherein the judgment means judges a content that is capable of being reproduced continuously based on the transmission rate of each content being downloaded and the standard reproduction rate of the content.

7. The reception apparatus according to claim 6,
wherein the download means measures the transmission rate of each content being downloaded in a state where downloads of contents other than the content as a target of the measurement are stopped, and
wherein the judgment means judges, based on the transmission rate of each content being downloaded and the standard reproduction rate of the content, a content that is capable of being reproduced continuously while the downloads of contents other than the content as the target of the measurement are stopped.

8. A content reception method, comprising:
downloading a content via a network;
storing the content being downloaded in a storage section;
judging, based on a transmission rate of the content being downloaded and a standard reproduction rate of the content, whether the content can be reproduced continuously; and
presenting a result of the judgment to a user.

9. A program causing a computer to operate as a reception apparatus, the program causing the computer to function as:
a download means for downloading a content via a network;
a storage section to store the content being downloaded;
a judgment means for judging, based on a transmission rate of the content being downloaded and a standard reproduction rate of the content, whether the content can be reproduced continuously; and
a presentation means for presenting a result of the judgment to a user.
